(19) United States
(12) Patent Application Publication
(10) Pub. No.: US 2006/0080118 A1
(43) Pub. Date: Apr. 13, 2006

(54) Method and system for self-remuneration of published material

(75) Inventor: Clifford Alan Pickover, Yorktown Heights, NY (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/963,941

(22) Filed: Oct. 13, 2004

(51) Int. Cl. G06Q 99/00

(52) U.S. Cl. 705/1

(57) ABSTRACT

The present invention introduces the notion of a service bureau that efficiently and automatically helps publishers receive, track, and reward consumers for finding errors in published material such as books, manuals, multimedia presentations, and e-books. In particular, described is a system and method for receiving one or more errors associated with published material over a computer network from one or more consumer reviewers, and remunerating the consumer reviewers based on a quality of the errors. The quality of errors is related to such factors as the number of errors received and the quality of error received.

### FIELD OF THE INVENTION

This invention relates to correcting errors in published materials. More specifically, the invention relates to a service bureau that facilitates the correction of errors in educational materials when these corrections are identified by consumers of said material.

### BACKGROUND OF THE INVENTION

In this fast-paced world, information in various fields of knowledge quickly becomes out of date. Similarly, published materials, such as textbooks, frequently contain errors of various kinds. For example, the complex and abstract nature of computer science, biology, and physics, makes these subjects difficult to understand. But complexity is not the only barrier to students understanding and appreciating science and mathematics. The subjects are made much more difficult by the presence of numerous misleading “myths” that have become so common and widespread that they even appear in science textbooks and are taught as facts in elementary school. Additionally, parents and students often find that books, pamphlets, CD ROMs, workbooks, web sites, and other published material incorrectly describe scientific laws. As reported in various news, parents sometimes write to textbook publishers to point out the errors; however, months can pass before the parent receives a response from the publisher. While waiting, parents often find additional mistakes, and students are taught using published material containing errors.

In some cases, the “authors” listed on the cover of textbooks do little more than outline topics for books; the actual writing and editing is done by committees of people who may not always be intimate with the subject matter. Sometimes, consumers, teachers, and school boards assume the information inside a book is accurate, and choose new textbooks for their students primarily based on packaging, which may include flashy graphics and illustrations—unaware that the published material contains errors or is not appropriate. Similarly, educational materials used in a corporation or for product documentation may contain errors, lack clarity, or be inappropriate for users of the material.

### PROBLEMS WITH THE PRIOR ART

Inaccurate and insubstantial documentation, textbooks, and training manuals create a problem for concerned parents, students, publishers, employers, and society as a whole. Recently, various educational organizations have published evaluations of popular textbooks and ranked them in order of content and usability. For example, Mathematically Correct, a California-based group, has thorough reviews of math books posted on their web site (www.mathmaticallycorrect.com). However, simple rankings and reports of errors in educational and other material does not efficiently solve the problem of correcting errors in the material and inducing people to find and report such errors.

Given problems such as these, an efficient and automatic method and system for correcting, supplying, managing, and remuneration users for finding errors becomes particularly important.

### OBJECTS OF THE INVENTION

An object of this invention is an improved system and method for receiving one or more errors associated with published material, such as educational material, over a computer network from one or more consumer reviewers and remunerating the consumer reviewers based on a quality of the errors.

### SUMMARY OF THE INVENTION

The present invention is a system, method, and service method for renumerating one or more reviewers for identifying one or more errors associated with published material over a computer network. The remuneration can be based on a quality of the errors.

### BRIEF DESCRIPTION OF THE FIGURES

The foregoing and other objects, aspects, and advantages will be better understood from the following non-limiting detailed description of preferred embodiments of the invention with reference to the drawings that include the following:

FIG. 1 is a block diagram on one preferred embodiment of the remuneration service bureau (RSB).

FIG. 2 is a flow chart showing the error submission and remuneration process.

FIG. 3 is a block diagram of one preferred embodiment of an error page maintained by the RSB.

### DETAILED DESCRIPTION OF THE INVENTION

The present invention addresses the above-mentioned limitations of the prior art by introducing the notion of a service bureau that efficiently and automatically helps publishers receive, track, and reward consumers for finding errors in published material such as books, manuals, multimedia presentations, and e-books. One preferred embodiment described is a system and method for receiving one or more errors associated with published material over a computer network from one or more consumer reviewers, and remunerating the consumer reviewers based on a quality of the errors. The quality of errors is related to such factors as the number of errors received and the type of error received. “Type” of error may refer to such aspects as missing information, incorrect information, factual errors, grammatical errors, and typographic errors. The system may be implemented by a remuneration service bureau (RSB) and the RSB may automatically change the value of the remuneration based on any many factors such as product sales figures or the nature of the content with errors.

Publishers frequently have errors in their textbooks, manuals, and documentation. When errors are found in teaching materials, such as textbooks, the error is sent to a “remuneration service bureau” (RSB), which returns a remuneration associated with that error. This bureau may route the errors to publishers who may provide the actual remuneration, for example, payment to a consumer's Internet account or to a school. In particular, the system described herein automatically and dynamically provides a remuneration to a consumer of published material when errors are encountered and reported. The remuneration may relate to the number and nature of errors. This system incents a publisher to distribute educational material that is as error-free as possible, and it incents users to purchase such material because they will receive a remuneration if errors are found.

Errors come in many forms. For example, some errors may be “annoyances.” For example, a textbook may have an obvious error like a grammar error, but the error does not affect the facts being learned. On the other hands, some errors are more egregious, for example, a page may be missing from the book, or the Middle Ages may be said to take place in 1870s. A particularly egregious error may actually be harmful to a consumer such as in an error in a document about medication or for a lawn mower. It is useful if a consumer of such information is paid or remunerated in some fashion when such errors are reported. Errors may occur in any type of content or media, for example, a book, an audio program, or a web site.

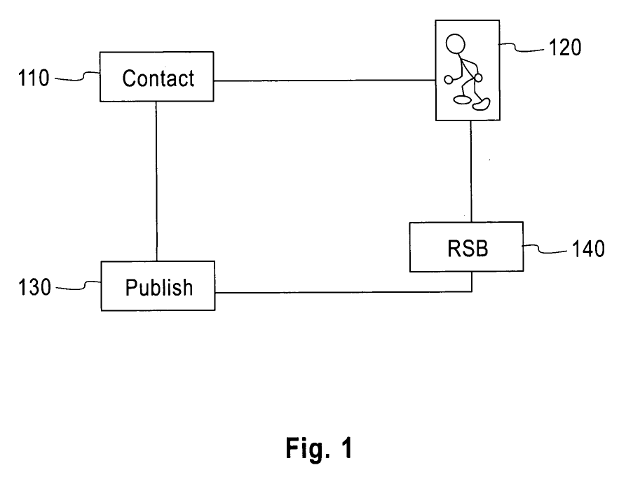

The following description details how the present invention is employed to manage error reporting and remuneration. FIG. 1 shows an exemplary environment embodying the present invention. It is initially noted that the environment is presented for illustration purposes only, and is representative of countless configurations in which the invention may be implemented. Thus, the present invention should not be construed as limited to the environment configurations shown and discussed herein. FIG. 1 shows content, such as educational material 110, and a consumer 120 of the material. The content is produced by a publisher 130. A remuneration service bureau (RSB) is shown in 140. The RSB operates the remuneration service and may be a service provided by a publisher or a separate entity such as a service bureau that runs this services for many different publishers.

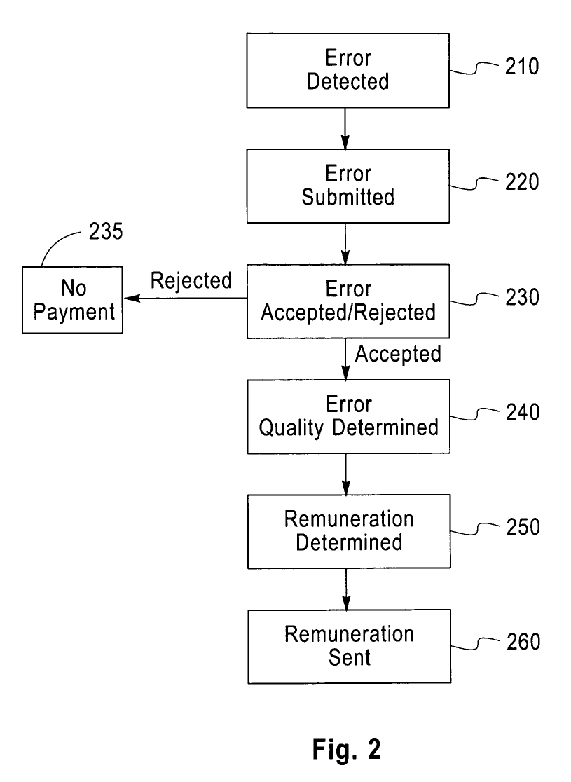

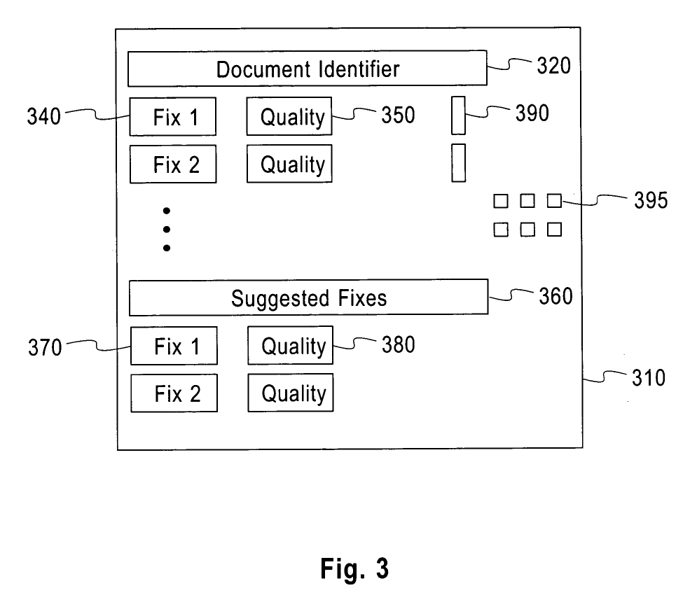

FIG. 2 shows an operating of the remuneration service, which may be run by a remuneration service bureau (RSB). In step, 210, a consumer of a material detects an error in the material such as a document, manual, or book. At this point, the consumer may elect to access an information page 310, such as a web page maintained by the RSB for the particular document, which gives an indication of errors and fixes that consumers have already found and also allows the user to enter new suggested fixes for errors. This information page is discussed later in the description for FIG. 3. In step 220, the consumer transmits the error to the RSB, which may be the content provider or creator, or a separate RSB, which may run a remuneration service for many different publishers. The transmission of the error from consumer to provider or RSB may be conducted using known methods of electronic communication, such as done by instant message, e-mail systems, or by filling a form on an information page on the web and transmitting the information using standard web-based methods. In step 230, the RSB examines the error and accepts it. For example, the consumer may have transmitted a spelling error to the RSB. The assessment and determination of the error may be done by a person or a software agent capable of making such assessments. For instance, the consumer may suggest that a spelling error exits on a particular page and line of an electronic document. In step 230, the system may automatically scan this sentence, compare the user's suggested word with the current word in a document page, determine that the current word is not spelled properly using an on-line dictionary, and then fix the spelling of the word in the on-line document or in future editions of printed documents if there was an error. If there is no error, no payment is made 235. In other instances, human analysis may be required by the RSB. For example, a user may suggest that the birthday of Beethoven is incorrect, and then the RSB system, in step 230, provides both the error (suggested by the consumer) and an on-line encyclopedia entry on Beethoven to a human analyst working for the RSB. Armed with this automatically supplied information, the human analyst may easily verify that the error and/or suggested fix is appropriate. Alternatively, it is possible for the system in step 230 to lookup information in various on-line information resources such as atlases, dictionaries, almanacs, and on-line encyclopedias. Thus, by automatically gathering consumer fixes and associating them with extant on-line resources, this system makes it easier for the RSB to manage fixes and reward users even if human analysts are sometimes required by the RSB. In step 240, the error quality is determined by the RMS. For example, the error may be a spelling error or a factual error. The consumer may enter the quality in table 310 as described later. In some cases, the RSB can automatically determine the quality by parsing the consumer's input using text analysis techniques or with the help of a human analyst working for the RSB. In step 250, a remuneration is determined. For example, the remuneration service may pay $5 for a factual error and $1 for a spelling error to the first five people to submit such errors. In step 260, the remuneration is sent. In any of the steps 210-260, the RSB may be paid for providing the service by software sellers, publishers, manufacturers, corporations, colleges, governments, or publication users.

Thus, in step 230, the RSB receives one or more errors, associated with published material, over a computer network from one or more consumer reviewers. In step 260, a remuneration is sent to the consumer reviewers based on a quality of the errors. The errors found may be found within one or more of the following kinds of material: a book, a manual, an e-book, a government document, a corporate document, a corporate training manual, an user manual, an operation manual, medical procedures manual, drug protocol specifications, medical documentation, legal documentation, a storage media, a compact disk, a computer memory, a digital video device (DVD), a memory stick, a software file, a web page, an HTML page, a JPEG file, an MPEG file, a poster, an interactive program, a multimedia presentation, or a streaming media. The quality of the error, which is determined in step 240, may relate to a number of errors received or to a type of error received. The type is any one or more of the following: missing information, incorrect information, factual errors, misleading information, ambiguous information, typographic errors, duplicate information, semantic errors, syntactic errors, grammatical errors, stylistic errors, reading level errors, relevance, recent developments in field, gender or racial bias errors, inappropriate portrayal of stereotypes (such as racial, gender, and age stereotypes), translation errors, and general appropriateness errors.

For example, consider the following information which may appear in a textbook: “The Middle Ages and Renaissance occurred between the years 50 and 100 AD. It is not evidant that it is important.”

Here we see a factual error (dates are incorrect), ambiguity (the second “it” is ambiguous), and a typographical spelling error (evidant). Reading level errors may refer to material that is too advanced for a particular age groups. Appropriateness errors ay refer to material that is not appropriate to a particular age level, such as a frank discussion of pornography. Some material may not be relevant to a particular topic. For example, it may not be relevant to know the number of bones in a human body when one is studying the death of Charlemange. Bias errors may refer to the lack of inclusion of women or minorities in texts. Translation errors refers to errors that appear when published material is translated into different languages. An example of an inappropriate stereotype is the inclusion of photos of women doing only housework.

Recent developments in technical fields can quickly render material obsolete. For example, the field of genetic engineering and computing is moving at a breathtaking pace, and material taught ten years ago may not be correct or be misleading to a current generation of readers.

The RSB may pay a remuneration, which is one or more of the following: money, goods, and services. The RSB may report one or more of the errors in a report. The report may be delivered to a publisher, an education institution, a company, a teacher, a student, or a parent of a student. The RSB may send the remuneration information to various computers servers, such as servers owned by publishers of educational content that will associate the error with a particular remuneration. Users of the RSB may pay the RSB for said service per day, week, month, or year.

In step 250, the remuneration bureau may automatically change the value of the remuneration based on any of: product sales figures (e.g., a publisher may pay more to receive errors for a best-selling book), nature of content (e.g., entertainment, educational, medical text, history), targeted age group of material, or rate of error submissions (e.g., if a book seems to have a lot of errors). The bureau may automatically increase the remuneration value for an error because it is embarrassing to have so many errors. The RSB may automatically decrease the remuneration, after N submissions of a particular error have been received (e.g., after 2 submissions, the remuneration follows a curve that rapidly decays to zero.) This may be presented visually so that 100 people do not try to submit the same error over a period of months. The RSB may make the errors visible (e.g. on a web page so that the public can see updates).

FIG. 3 shows a information page 310, such as a web page displayed on any well known computer interface, that may present current available fixes for errors for a document. The information page 310 may also permit consumers to suggest new errors and fixes. For example, text field 320 is a document identifier, which may contain such fields as book title, author, and/or ISBN number for a book, document, or manual. Field 340 is one currently known fix for an error in the material. For example, field 340 may contain a description such as, “Page 340, ‘Mr. Smith’ should be replaced by ‘Mr. Jones.” The quality associated with this fix may be displayed in field 350. For example, the quality might be “spelling error,” “factual error,” “grammar error,” “ambiguity error,” and so forth. One purpose for displaying current fixes is to discourage consumers from taking the trouble to entering errors and fixes that are already known to the publisher. Current fixes can be grouped by location in a work, e.g., by page and line, so that fixes at the same location in a document are grouped together.

In the fields below field 360 are new fixes entered by a consumer. For example, in field 370, a consumer of a science text book may enter a factual error found on a particular page and a suggest a fix, along with a quality 380 associated with the error and fix. Similarly, in field 370, the user may enter a word that is currently misspelled in a book on a particular page and line number of the book and suggest a correctly-spelled substitution. By providing an information page 310, the RSB makes it easier to convey currently known fixes and to allow users to enter new suggested errors and fixes in a convenient manner. By allowing the display and input of qualities, the RSB makes it easier to understand the currently-known fixes and also makes it easier to categorize new suggestions for errors and fixes. Sometimes, users may enter faulty information for both fixes 370 and qualities 380, but by permitting the neat and standardized input of such information in an information page 310, it will be easier for a human analyst working for the RSB to review, understand, and assess consumer suggestions.

The RSB system may automatically learn a consumer's “reliability” of providing correct fixes through an analysis of past suggested fixes. For example, a consumer may have provided ten valid fixes for various qualities of error and thus may be considered very reliable. The consumer's reward (remuneration) may be a function of this history. For example, a user with an excellent track record may receive bonuses. Additionally, the system may automatically tend to accept suggested fixes 370 from consumers with excellent histories of providing valid fixes. For example, fewer human analysts at the RSB may be required to check fixes of those consumers with the best track records of providing valid fixes. These consumers with excellent track records may be automatically invited to become analysts for the RSB.

In addition to the use of the RSB by publishers, entities such as authors of published materials may use the RSB to provide them with errors and fixes, before or after the material is published. If the author or publisher wishes to receive corrections for pre-publication materials, it is possible for the RSB to provide restricted access to the information page 310 to a limited number of potential error-checking people such as those people with excellent track records for finding errors and suggesting fixes. Thus, the information page may be password protected. Others may gain access to the page for a fee. The RSB may also provide a service for displaying potential errors and fixes, such as those displayed on information page 310, without the RSB providing a checking service that actually makes the changes in published documents or without the RSB checking all suggested fixes to see if these suggested fixes are accurate. A “confirmed” field 390 on information sheet 310 can indicate that a suggested fix is correct, been implemented in the published material, and/or has not been checked. The confirm field may also indicate a degree of confidence with respect to a correction. For example, the RSB may be 90% confident that a suggested fix is correct. This degree of confidence may be indicated to users in the form of color or other visually distinguishing features. For example, green may indicate a high confidence in a particular fix, whereas a blue may indicate a lower confidence. Confidence assessment may be accomplished by many means such as through the use of automatic means such as spell checkers or by voting by analysts at the RSB, voting by consumers, and so forth. Summary information may also be presented on information page 310, such as the total number of errors found in a document and the number of errors of a particular type as a function of time. A peer-to-peer system may be used to implement all or part of the RSB functioning. For example, an author's or publisher's electronic documents may reside on their own computing machines, which also maintain error and fix data.

Information page 310 may also provide information specifying a remuneration rate 395 for each type of error, and this rate may change through time according to various criteria. For example, the publisher may offer $1 for spelling errors and $5 for factual errors. The rate maybe computed automatically based on a document's age, size, type, sales status (e.g. bestseller), time of the month, topic, and other criteria. A consumer may access information page 310 to see the current remunerations available. Additionally, the information page 310 may be presented by booksellers, such as Amazon.com, so that consumers may conveniently provide fixes at these popular web sites.

The foregoing description of the invention has been presented for purposes of illustration and description. It is not intended to be exhaustive or to limit the invention to the precise form disclosed, and other modifications and variations may be possible in light of the above teachings. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

We claim:

1. A method comprising the steps of:
receiving one or more errors associated with published material over a computer network from one or more consumer reviewers; and
remunerating the consumer reviewers based on a quality of the errors.

2. A method of claim 1 wherein the published material is one or more of the following: a book, a manual, an e-book, a government document, a corporate document, an internal corporate document, a corporate training manual, an user manual, an operation manual, medical procedures manual, drug protocol specifications, medical documentation, legal documentation, a storage media, a compact disk, a computer memory, a digital video device (DVD), a memory stick, a software file, a web page, an HTML page, a JPEG file, an MPEG file, a poster, an interactive program, a multimedia presentation, and a streaming media.

3. A method of claim 1 wherein the quality of the error is related to a number of errors received.

4. A method of claim 1 wherein the quality is related to a type of error received.

5. A method of claim 4 wherein the type is any one or more of the following: missing information, incorrect information, factual errors, misleading information, ambiguous information, typographic errors, duplicate information, semantic errors, syntactic errors, grammatical errors, translation errors, stylistic errors, reading level errors, enhancements, recent developments in field, relevance, in appropriate stereotypes, and appropriateness errors.

6. A method of claim 1 wherein the remuneration is one or more of the following: money, goods, and services.

7. A method of claim 1 further comprising the step of: reporting one or more of the errors in a report.

8. A method of claim 7 wherein the report is delivered to one or more of the following: a publisher, a consumer, an education institution, a teacher, a student, a parent.

9. A method of claim 1 that is performed by a bureau as a service.

10. A method of claim 9 where one or more of the following pays the bureau for the service: a software seller, a publisher, a manufacturer, a corporation, a college, a government, and a document user.

11. A system for remunerating one or more customer reviewers, the system having one or more central processing units (CPUs), one or more memories, and one or more network connections, the system further comprising:
a receiving process that receives one or more errors associated with published material over a computer network from one or more consumer reviewers; and
a remunerating process that remunerates the consumer reviewers based on a quality of the errors.

12. A system of claim 11 wherein the system is operated by one or more publishers of published material, the publishers associating each of the errors with a remuneration amount.

13. A system of claim 12 wherein a remuneration amount depends on one or more of the following: a published material sales figure, a nature of published material content, a targeted age group of the published material, and a rate of error submissions.

14. A system of claim 11 wherein the remuneration amount is decreased automatically after N submissions of the error have been received.

15. A system of claim 11 further comprising a report generator that generates a report of one or more of the errors.

16. A system of claim 15, where the report includes one or more of the following: an error statistic, a graph, a table, a public document, and an electronic document.

17. A system comprising:
means for receiving one or more errors associated with published material over a computer network from one or more consumer reviewers; and
means for remunerating the consumer reviewers based on a quality of the errors.

18. A service method comprising the steps of:
a service bureau receiving one or more errors associated with published material over a computer network from one or more consumer reviewers; and
remunerating, by the service bureau, the consumer reviewers based on a quality of the errors.

19. A service method of claim 18 further comprising the step of the service bureau receiving publisher payment from one or more publishers.

20. A service method of claim 19 wherein the publisher payments are received in one or more of the following ways: per day, per week, per month, and per year.

21. A service method of claim 18 wherein the remuneration bureau automatically decreases the remuneration after N submissions of the errors has been received.
